(19) United States
(12) Patent Application Publication
(10) Pub. No.: US 2022/0082914 A1
(43) Pub. Date: Mar. 17, 2022

(54) WIRELESS SCREEN PROJECTION DEVICE

(71) Applicant: Tuofushi (Shenzhen) Industrial Co., Ltd, Shenzhen (CN)

(72) Inventor: Li Zhang, Shenzhen (CN)

(21) Appl. No.: 17/448,880

(22) Filed: Sep. 25, 2021

(30) Foreign Application Priority Data
Sep. 14, 2021 (CN) 202122239184.5

(51) Int. Cl. G03B 21/14; G03B 21/16; H04W 4/80

(52) U.S. Cl. CPC G03B 21/145; H04W 4/80; G03B 21/16

(57) ABSTRACT

The present disclosure discloses a wireless screen projection device including a transmitting device and a base. The transmitting device is removably electrically connected to the base, and includes a shell assembly, a control panel, a plurality of I/O interfaces, a first electrical connection piece, a button assembly, and a heat dissipation device. The shell assembly is a hollow cavity. The control panel is fixedly arranged in the shell assembly and is provided with a wireless communication module. The plurality of I/O interfaces are provided on the control panel and penetrate through the shell assembly. The first electrical connection piece is electrically connected with the base. The button assembly is arranged on the control panel penetrates through the shell assembly, and can switch connection to different projected equipment and be matched with a projection device. The heat dissipation device is fixedly arranged in the shell assembly.

### TECHNICAL FIELD

The present disclosure relates to the technical field of screen projection equipment, and specifically relates to a wireless screen projection device.

### BACKGROUND

At present, wireless screen projection devices are widely used in various fields. The wireless screen projection office field is taken as an example. In a conference scene, speakers often use wireless projection devices to display screen images of terminal devices such as laptops by means of a large-size display screen or project same through a projector, so as to display reports, analysis data and other information in the PPT slides shown by the laptops to participants by means of the large-size display screen or projector.

The existing wireless screen projection device includes a transmitter and a receiver. The transmitter and the receiver are connected wirelessly, and are usually in a WiFi connection. The transmitter is provided with a data transmission interface such as a USB interface and an HDMI interface connected to a laptop through a data wire, and a wireless transmission module (such as a Wifi module) for realizing wireless connection to the receiver. The receiver is provided with a data transmission interface such as an HDMI interface for being connected to the large-size display screen or projector through a data wire, and a wireless transmission module (such as a Wifi module) for realizing wireless connection to the transmitter. When wireless projection is needed, the transmitter is connected to the laptop, and the receiver is connected to the large-size display or projector. A screen image of the laptop can be sent to the receiver through the transmitter and then displayed on the large-size display screen or projector. The existing wireless screen projection device is not perfect in function, and has problems such as inconvenient switching between different projected equipment, which affects the user experience. Therefore, in view of the deficiencies in the actual manufacturing and implementation of the above-mentioned solutions, the above-mentioned solutions are revised and improved. At the same time, in line with the spirit for good and the idea, aided by professional knowledge and experience, by multiple clever thoughts and tests, this design is provided. Therefore, a wireless screen projection device is provided to solve the above-mentioned problems.

### SUMMARY

One of the purposes of the present disclosure is to provide a wireless screen projection device, so as to solve the above-mentioned problems.

The wireless screen projection device of the present disclosure can be realized by means of the following technical solutions:

the wireless screen projection device of the present disclosure includes a transmitting device and a base. The transmitting device is removably electrically connected to the base, and includes a shell assembly, a control panel, a plurality of I/O interfaces, a first electrical connection piece, a button assembly, and a heat dissipation device. The shell assembly is a hollow cavity. The control panel is fixedly arranged in the shell assembly and is provided with a wireless communication module. The plurality of I/O interfaces are provided on the control panel and penetrate through the shell assembly. The first electrical connection piece is electrically connected with the base. The button assembly is arranged on the control panel, penetrates through the shell assembly, and can switch connection to different projected equipment and be matched with a projection device. The heat dissipation device is fixedly arranged in the shell assembly.

In one implementation mode, the I/O interfaces include an HDMI input interface, an HDMI output interface, a USB interface, and a TYPE C interface.

In one implementation mode, the wireless communication module is a Bluetooth communication module, a WIFI communication module, or a millimeter wave communication module.

In one implementation mode, the wireless screen projection device of the present disclosure further includes an atmosphere light including a bracket and a light strip; the bracket is fixedly arranged in the shell assembly; the light strip is wound on the bracket.

In one implementation mode, the wireless screen projection device of the present disclosure further includes a display screen arranged in the shell assembly.

In one implementation mode, the base includes a base shell, a power board, an energy storage device, a power switch, a charging interface, a voltage conversion device, and a second electrical connection piece; the base shell is a hollow cavity; the power board, the energy storage device, and the voltage conversion device are fixedly arranged in the base shell; the power switch is arranged on the power board and penetrates through the base shell; the charging interface is electrically connected to the power board and penetrates through the base shell; two ends of the second electrical connection piece are electrically connected to the voltage conversion device and the first electrical connection piece, respectively.

In one implementation mode, the power board is provided with a plurality of LED display lamps.

In one implementation mode, the energy storage device is a rechargeable battery.

In one implementation mode, the charging interface includes an adapter board and a charging interface main body; the adapter board is electrically connected with the power board; the charging interface main body is arranged on the adapter board and penetrates through the base shell.

In one implementation mode, the button assembly includes a switching button and a matching button.

Compared with the existing art, the wireless screen projection device of the present disclosure has the beneficial effects.

The wireless screen projection device of the present disclosure is connected to a plurality of sets of projected equipment in a wired manner through the HDMI input interface and the TYPE C interface, connected to a keyboard and/or a mouse through the USB interface, and wirelessly connected to the projection device through the millimeter wave communication module. The switching button is pressed to switch different projected equipment to effectively realize free switching and fast transmission functions of the plurality of sets of different projected equipment. By means of the detachable electrical connection design between the base and the transmitting device, it is convenient for storage and carrying of the transmitting device, which also effectively reduces the volume of the transmitting device. Meanwhile, the atmosphere light is arranged on the transmitting device, which enhances the client experience to a certain extent.

### BRIEF DESCRIPTION OF THE DRAWINGS

In order to explain the technical solutions of the embodiments of the present disclosure more clearly, the following will briefly introduce the accompanying drawings used in the embodiments. It should be understood that the drawings in the following description only illustrate some embodiments of the present disclosure and thus shall not be deemed as limiting the scope. Those of ordinary skill in the art can obtain other related drawings according to these drawings without creative work.

FIG. 1 is a schematic diagram of an external structure of a wireless screen projection device of the present disclosure;

FIG. 2 is a schematic diagram of an external structure of anther side surface of the wireless screen projection device of the present disclosure shown in FIG. 1;

FIG. 3 is a schematic diagram of a longitudinal section of the wireless screen projection device of the present disclosure shown in FIG. 1;

FIG. 4 is a schematic structural diagram after a transmitting device and a base in the wireless screen projection device of the present disclosure shown in FIG. 1 are separated;

FIG. 5 is a schematic exploded structural diagram of a base in the wireless screen projection device of the present disclosure shown in FIG. 1;

FIG. 6 is a schematic exploded structural diagram of a transmitting device in the wireless screen projection device of the present disclosure shown in FIG. 1.

Reference signs in the drawings: 10: transmitting device; 11: shell assembly; 111: main shell; 112: cover plate; 1121: interface hole; 1122: heat dissipation hole; 12: control panel; 13: interface; 14: first electrical connection piece; 15: atmosphere light; 151: bracket; 152: light strip; 16: display screen; 17: button assembly; 18: heat dissipation device; 20: base; 21: base shell; 22: power board; 23: energy storage device; 24: power switch; 25: charging interface; 251: adapter board; 252: charging interface main body; 26: voltage conversion device; 27: second electrical connection piece.

### DETAILED DESCRIPTION OF THE EMBODIMENTS

In order to make the objectives, technical solutions and advantages of the embodiments of the present disclosure clearer, the technical solutions in the embodiments of the present disclosure will be described clearly and completely below in combination with the drawings in the embodiments of the present disclosure. Obviously, the embodiments described are part of the embodiments of the present disclosure, not all the embodiments. The components of the embodiments of the present disclosure generally described and shown in the drawings here can be arranged and designed in a variety of different configurations.

Therefore, the following detailed description for the embodiments of the present disclosure provided in the accompanying drawings is not intended to limit the scope of the claimed present disclosure, but merely represents selected embodiments of the present disclosure. Based on the embodiments in the present disclosure, all other embodiments obtained by those of ordinary skill in the art without creative work shall fall within the protection scope of the present disclosure.

It should be noted that similar reference signs and letters indicate similar items in the following drawings. Therefore, once a certain item is defined in one drawing, it is unnecessary to be further defined and explained in the subsequent drawings.

In the description of the present disclosure, it should be noted that orientations or positional relationships indicated by the terms “upper”, “lower”, and the like are orientations or positional relationships as shown on the basis of the drawings, or orientations or positional relationships where this utility model product are usually placed, and are only for the purpose of facilitating and simplifying the description of the present disclosure instead of indicating or implying that devices or elements indicated must have particular orientations, and be constructed and operated in the particular orientations, so that these terms cannot be construed as limiting the present disclosure.

In addition, in the present disclosure, unless otherwise clearly specified and defined, the first feature being “above” or “under” the second feature may include that the first and second features are in direct contact, or may include that the first and second features are not in direct contact but in contact through other features between them. Moreover, the first feature being “on”, “at the upper side of”, and “on the upper surface of” the second feature includes that the first feature is right above and at the oblique upper side of the second feature, or only indicates that the horizontal height of the first feature is greater than that of the second feature. The first feature being “below”, “at the lower side of”, and “on the lower surface of” the second feature includes that the first feature is right below and at the oblique lower side of the second feature, or only indicates that the horizontal height of the first feature is less than that of the second feature.

In addition, the terms “horizontal”, “vertical”, and the like do not mean that the component is required to be absolutely horizontal or overhanging, but may be slightly inclined. For example, “horizontal” only means that its direction is more horizontal than “vertical”, and it does not mean that the structure must be completely horizontal, but can be slightly inclined.

In the description of the present disclosure, it should be also noted that unless otherwise explicitly defined and defined, the terms “arranged”, “coupled”, and “connected” shall be understood broadly, and may be, for example, fixedly connected, or removably connected, or integrally connected, or mechanically connected, or electrically connected, or directly connected, or indirectly connected through an intermediate medium, or interconnection between two elements. Those of ordinary skill in the art can understand the specific meanings of the above terms in the present disclosure according to specific situations.

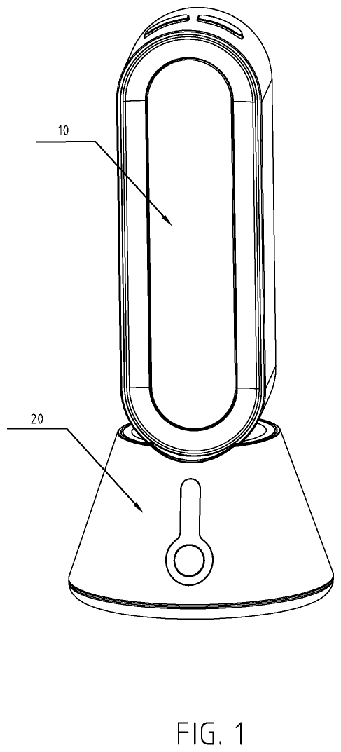

Referring to FIG. 1-FIG. 4, a wireless screen projection device of the present disclosure includes a transmitting device 10 and a base 20. The transmitting device 10 is removably electrically connected to the base 20. The transmitting device 10 is wirelessly connected to a projection device. The projection device can be a large-size display screen or projector. The base 20 provides electric energy for the transmitting device 10.

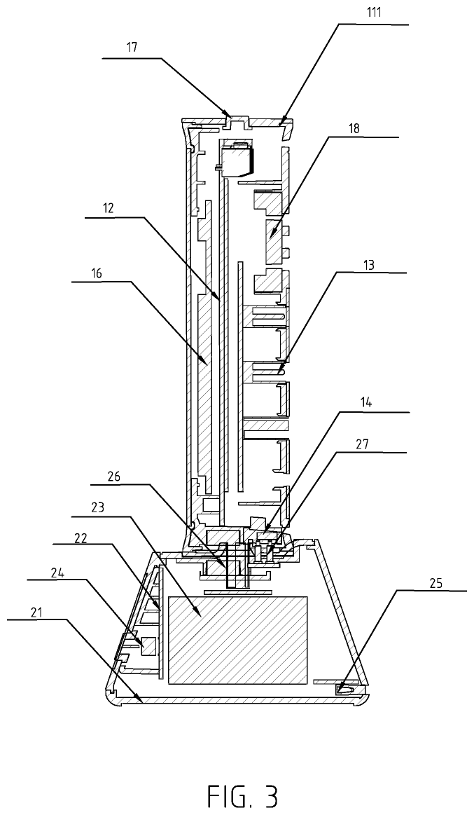

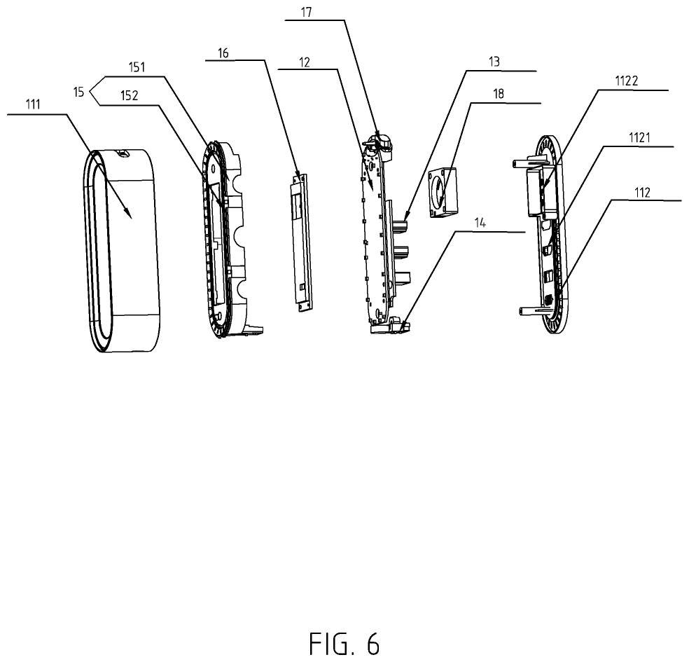

Referring to FIG. 3 and FIG. 6, in the present embodiment, the transmitting device 10 includes a shell assembly 11, a control panel 12, a plurality of I/O interfaces 13, a first electrical connection piece 14, an atmosphere light 15, a display screen 16, a button assembly 17, and a heat dissipation device 18. The shell assembly 11 is a hollow cavity. The control panel 12 is fixedly arranged in the shell assembly 11 and is electrically connected with the plurality of I/O interfaces 13, the first electrical connection piece 14, the atmosphere light 15, the display screen 16, the button assembly 17, and the heat dissipation device 18, respectively. The plurality of I/O interfaces 13 are arranged on the control panel 12 and penetrates through the shell assembly 11. The I/O interfaces 13 include an input interface and an output interface. The input interface can be connected to input equipment which includes, but is not limited to, projected equipment, a keyboard or a mouse. The output interface can be connected with a projection device. The first electrical connection piece 14 is electrically connected with the base 20 so that the base 20 supplies power to the control panel 12. The atmosphere light 15 is fixedly arranged in the shell assembly 11, and light emitted by it can penetrate through the shell assembly 11. The atmosphere light 15 is used to create an atmosphere or illumination. The display screen 16 is arranged in the shell assembly 11, is electrically connected with the control panel 12 and is used to realize visual displaying. The button assembly 17 is arranged on the control panel 12, penetrates through the shell assembly 11 and can switch connection to different projected equipment and be matched with the projection equipment. The heat dissipation device 18 is fixedly arranged in the shell assembly 11 and is used to dissipate heat of the control panel 12.

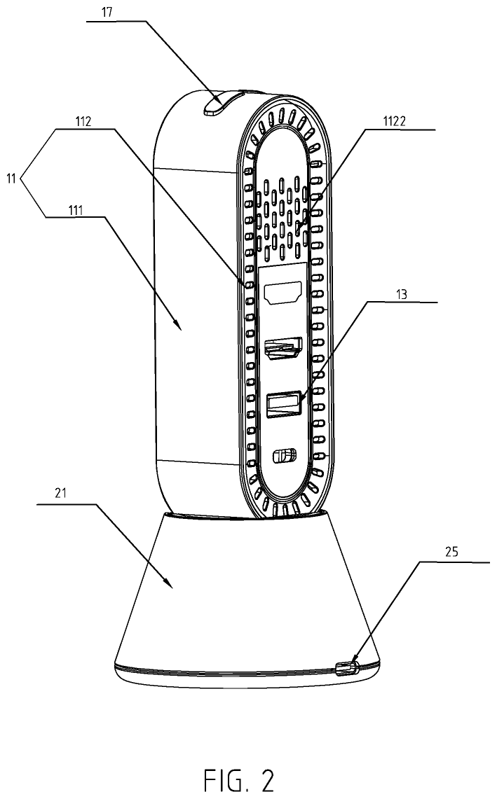

Referring to FIG. 2 and FIG. 6, the shell assembly 11 includes a main shell 111 and a cover plate 112. The main shell 111 and the cover plate 112 are connected through a buckle structure or a screw structure. In the present embodiment, the main shell 111 and the cover plate 112 are connected through the buckle structure. In the present embodiment, the cover plate 112 is provided with a plurality of interface holes 1121 and a plurality of heat dissipation holes 1122. The positions of the plurality of interface holes 1121 are corresponding to the positions of the corresponding I/O interfaces 13. The plurality of heat dissipation blocks 1122 are uniformly distributed on the cover plate 1121 so that it is convenient to dissipate the heat in the shell assembly 11. In some other embodiments, the plurality of interface holes 1121 and the heat dissipation holes 1122 can also be formed in the main shell 111.

Referring to FIG. 3 and FIG. 6, in the present embodiment, the control panel 12 is electrically connected with the I/O interfaces 13, the first electrical connection piece 14, the atmosphere light 15, the display screen 16, the button assembly 17, and the heat dissipation device 18, respectively. The control technology used is the existing art, so descriptions thereof are omitted. The control panel 12 is provided with a wireless communication module and is wirelessly connected with the projection device through the wireless communication module. The wireless communication module can be a Bluetooth communication module, a WIFI communication module or a millimeter wave communication module. In the present embodiment, the wireless communication module uses the millimeter wave communication module. Since the millimeter wave communication module has a high frequency band, there is basically no interference source, and an electromagnetic spectrum is extremely clean. Therefore, a millimeter wave communication channel is stable and reliable, and an error rate can be maintained at 10-12 magnitude for a long time.

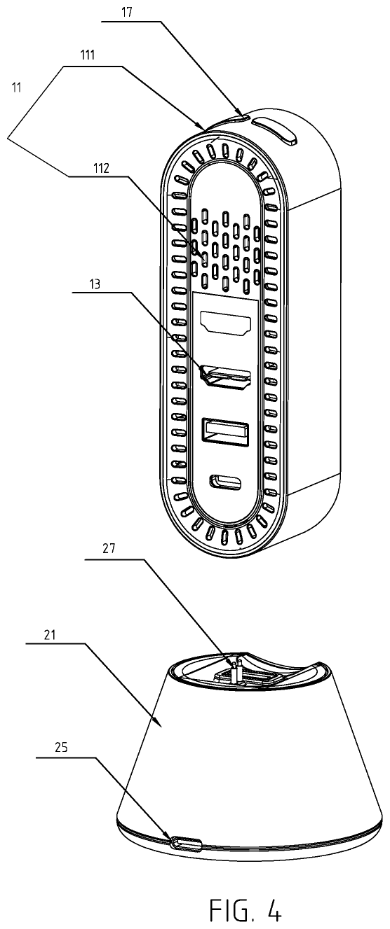

Referring to FIG. 3, FIG. 4, and FIG. 6, the I/O interfaces 13 include an HDMI input interface, an HDMI output interface, a USB interface, and a TYPE C interface. The HDMI input interface is used to input high-definition video data and is connected to a host of the projected equipment. The HDMI output interface is used to output the high-definition video data and is connected to a host of the projection equipment. The USB interface is used to be connected to input equipment such as a keyboard and/or a mouse. The USB interface supports an OTG function. The TYPE C interface is used to be connected to a power supply or to input the high-definition video data. In the present embodiment, the HDMI input interface and the TYPE C interface are connected with a plurality of sets of projected equipment in a wired manner; the USB interface is connected to the keyboard and/or mouse; the projection equipment is connected through the HDMI output interface, or the projection device is connected through the wireless communication module; the different projected equipment can be switched through the button assembly 17; the different projected equipment is controlled through the keyboard and/or mouse.

Referring to FIG. 6, in the present embodiment, the atmosphere light 15 includes a ringlike bracket 151 fixedly arranged in the shell assembly 11, and a light strip 152 wound on the bracket 151. The display screen 16 is an LED display screen or an LCD display screen. In the present embodiment, the display screen 16 uses the LED display screen. In the present embodiment, the button assembly 17 includes a switching button and a matching button. The different projected equipment can be switched through the switching button, and the projection device needing to be connected is subjected to matching connection through the matching button. In the present embodiment, a placement cavity is formed in the inner wall of the cover plate 112, and the heat dissipation device 18 is fixedly arranged in the placement cavity. Preferably, the heat dissipation device 18 is a fan.

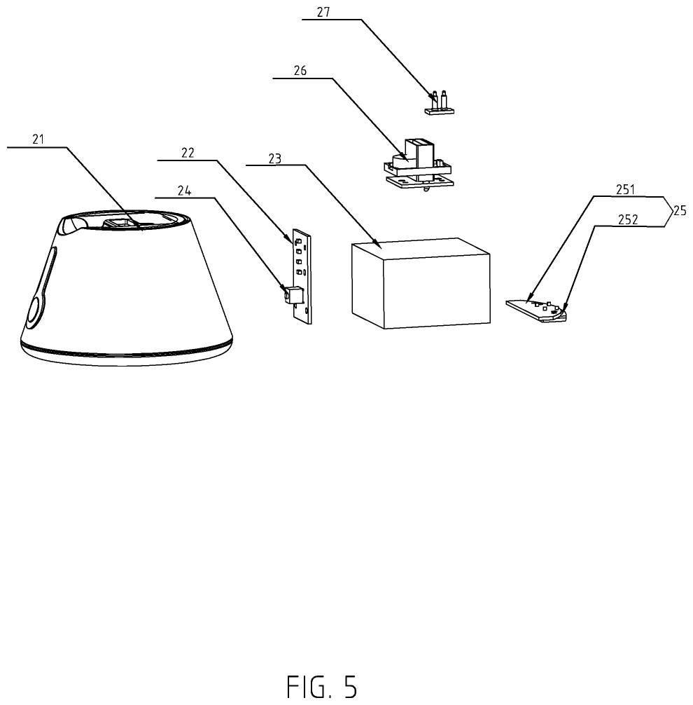

Referring to FIG. 1, FIG. 3, and FIG. 5, in the present embodiment, the base 20 includes a base shell 21, a power board 22, an energy storage device 23, a power switch 24, a charging interface 25, a voltage conversion device 26, and a second electrical connection piece 27. The base shell 21 is a hollow cavity. The power panel 22 and the energy storage device 23 are fixedly arranged in the base shell 21. The power board 22 is electrically connected to the energy storage device 23, the power switch 24, the charging interface 25, and the voltage conversion device 26, respectively. The energy storage device 23 provides electric energy for the transmitting device 10. The power switch 24 is arranged on the power board 22, penetrates through the base shell 21, and controls the energy storage device 23 to be turned on or turned off. The charging interface 25 is electrically connected with the power board 22, penetrates through the base shell 21, and is used to charge the energy storage device 23. The voltage conversion device 26 is arranged in the base shell 21 and is used for voltage conversion so that an output voltage is matched with a working voltage of the transmitting device 10. Two ends of the second electrical connection piece 27 are electrically connected to the voltage conversion device 26 and the first electric connection piece 14, respectively, so as to supply energy to the control panel 12.

Referring to FIG. 3 and FIG. 5, in the present embodiment, the base shell 21 is conical. In other embodiments, the base shell 21 may also be cylindrical, rectangular, or of other shapes. In order to facilitate better fixing the transmitting device 10 on the base shell 21, magnets are arranged in both the transmitting device 10 and the base shell 21, such that the transmitting device 10 is stably placed on the base shell 21 by means of mutual attraction between the magnets. The power board 22 is electrically connected to the energy storage device 23, the power switch 24, the charging interface 25, and the voltage conversion device 26, respectively. The technologies used all belong to the existing art, so descriptions thereof are omitted. The power board 22 is further provided with a plurality of LED display lamps that penetrate through the base shell 21. An electric quantity of the energy storage device 23 and an electric quantity in a charging process can be displayed by means of the LED display lamp.

Referring to FIG. 3 and FIG. 5, the energy storage device 23 is a rechargeable battery. Preferably, the energy storage device 23 is a lithium ion polymer battery. In the present embodiment, the charging interface 25 includes an adapter board 251 and a charging interface main body 252. The adapter board 251 is electrically connected with the power board 22. The charging interface main body 252 is provided on the adapter board 251 and penetrates through the base shell 21. In some other embodiments, the charging interface main body 252 can be directly provided on the power board 22. The energy storage device 23 is charged by means of the charging interface main body 252. The interface type of the charging interface main body 252 is a Micro USB interface, a Lightning interface or a Type C interface. Preferably, the charging interface main body 252 uses the Type C interface.

Referring to FIG. 3, the first electrical connection piece 14 is arranged on the transmitting device 10, and the second electrical connection piece 27 is arranged on the base 20. By means of contact connection between the first electrical connection piece 14 and the second electrical connection piece 27, the energy storage device 23 supplies power to the control board 12. In the present embodiment, the first electrical connection piece 14 is an electrical contact point, and the second electrical connection piece 27 is an electrical contact pin. In some other embodiments, the first electrical connection piece 14 is an electrical contact pin, and the second electrical connection piece 27 is an electrical contact point.

It should be noted that the wireless screen projection device of the present disclosure can be connected with a plurality of sets of projected equipment through the I/O interfaces 13, and is wirelessly connected with the projection device through the millimeter wave communication module, and the different projected equipment can be freely switched through the switching button. The control board 12 is powered by the base 20, or may be powered by being connected, through the TYPE C interface, to a power supply. The detachable electrical connection between the transmitting device 10 and the base 20 is realized by means of the contact connection between the first electrical connection piece 14 and the second electrical connection piece 27 so that storage of equipment is facilitated, and the volume of the transmitting device 10 is also effectively reduced.

The technical features of the embodiments described above can be arbitrarily combined. In order to make the description concise, all possible combinations of various technical features in the above embodiments are not completely described. However, the combinations of these technical features should be considered as the scope described in the present specification as long as there is no contradiction in them.

The above-mentioned embodiments only express several implementation modes of the present disclosure, and their descriptions are more specific and detailed, but they cannot be understood as limiting the patent scope of the present disclosure. It should be noted that those of ordinary skill in the art can further make various transformations and improvements without departing from the concept of the present disclosure, and these transformations and improvements all fall within the protection scope of the present disclosure. Therefore, the protection scope of the patent of the present disclosure shall be subject to the appended claims.

What is claimed is:

1. A wireless screen projection device, comprising a transmitting device and a base, wherein the transmitting device is removably electrically connected to the base, and comprises a shell assembly, a control panel, a plurality of I/O interfaces, a first electrical connection piece, a button assembly, and a heat dissipation device; the shell assembly is a hollow cavity; the control panel is fixedly arranged in the shell assembly and is provided with a wireless communication module; the plurality of I/O interfaces are provided on the control panel and penetrate through the shell assembly; the first electrical connection piece is electrically connected with the base; the button assembly is arranged on the control panel, penetrates through the shell assembly, and can switch connection to different projected equipment and be matched with a projection device; and the heat dissipation device is fixedly arranged in the shell assembly.

2. The wireless screen projection device according to claim 1, wherein the I/O interfaces comprise an HDMI input interface, an HDMI output interface, a USB interface, and a TYPE C interface.

3. The wireless screen projection device according to claim 1, wherein the wireless communication module is a Bluetooth communication module, a WIFI communication module, or a millimeter wave communication module.

4. The wireless screen projection device according to claim 1, further comprising an atmosphere light comprising a bracket and a light strip, wherein the bracket is fixedly arranged in the shell assembly; the light strip is wound on the bracket.

5. The wireless screen projection device according to claim 1, further comprising a display screen arranged in the shell assembly.

6. The wireless screen projection device according to claim 1, wherein the base comprises a base shell, a power board, an energy storage device, a power switch, a charging interface, a voltage conversion device, and a second electrical connection piece; the base shell is a hollow cavity; the power board, the energy storage device, and the voltage conversion device are fixedly arranged in the base shell; the power switch is arranged on the power board and penetrates through the base shell; the charging interface is electrically connected to the power board and penetrates through the base shell; two ends of the second electrical connection piece are electrically connected to the voltage conversion device and the first electrical connection piece, respectively.

7. The wireless screen projection device according to claim 6, wherein the power board is provided with a plurality of LED display lamps.

8. The wireless screen projection device according to claim 6, wherein the energy storage device is a rechargeable battery.

9. The wireless screen projection device according to claim 6, wherein the charging interface comprises an adapter board and a charging interface main body; the adapter board is electrically connected with the power board; the charging interface main body is arranged on the adapter board and penetrates through the base shell.

10. The wireless screen projection device according to claim 1, wherein the button assembly comprises a switching button and a matching button.
